(19) United States
(12) Patent Application Publication
(10) Pub. No.: US 2025/0196839 A1
(43) Pub. Date: Jun. 19, 2025

(54) APPARATUS AND METHOD FOR PREVENTING BRAKE RESPONSE DELAY

(71) Applicants: HYUNDAI MOTOR COMPANY, SEOUL (KR); KIA CORPORATION, SEOUL (KR)

(72) Inventor: Dong Hoon Kang, Seoul (KR)

(73) Assignees: HYUNDAI MOTOR COMPANY, SEOUL (KR); KIA CORPORATION, SEOUL (KR)

(21) Appl. No.: 18/676,952

(22) Filed: May 29, 2024

(30) Foreign Application Priority Data
Dec. 13, 2023 (KR) 10-2023-0181219

(51) Int. Cl. B60W 10/18

(52) U.S. Cl. CPC B60W 10/18; B60W 2520/10; B60W 2720/106

(57) ABSTRACT

An apparatus for preventing a brake response delay of a vehicle is provided. The apparatus for preventing the brake response delay of the vehicle includes at least one processor and a non-transitory memory storing computer-executable instructions executable by the at least one processor to perform the operations including determining whether a host vehicle is located within a risk section with reference to position information, by a risk section determination device, and outputting first required acceleration with reference to a current speed of the host vehicle and a setting speed range, based on determination that the host vehicle is located within the risk section, by an acceleration output device, and outputting second required acceleration corresponding to a deceleration trigger signal, based on obtainment of the deceleration trigger signal, by the acceleration output device.

### CROSS REFERENCE TO RELATED APPLICATIONS

This application claims the benefit of priority to Korean Patent Application No. 10-2023-0181219, filed in the Korean Intellectual Property Office on Dec. 13, 2023, the entire contents of which are incorporated herein by reference.

### TECHNICAL FIELD

The present disclosure relates to an apparatus and a method for preventing a brake response delay.

### BACKGROUND

When a braking command is transmitted to a sub-controller while a host vehicle (e.g., autonomous vehicle) is traveling depending to a driving command, it takes a certain time to generate brake pressure for braking. A delay occurs until the autonomous vehicle actually switches to its braking state. Due to such a brake response delay, an actual stopping distance until the autonomous vehicle stops is greater than a target stopping distance.

In addition, although a specific situation occurs (e.g., a person suddenly appears on a driving route of the autonomous vehicle or a vehicle which is traveling on a next lane cuts in from a close distance) in a zone with a high risk of accident occurrence (e.g., a school zone, a habitually illegal parking area, or the like), when the actual stopping distance is greater than the target stopping distance due to the brake response delay, a possibility of fatal accident occurrence increases.

Thus, a method for preventing a brake response delay of a vehicle is being studied.

### SUMMARY

The present disclosure has been made to solve the above-mentioned problems occurring in the prior art while advantages achieved by the prior art are maintained intact.

An aspect of the present disclosure provides an apparatus and a method for preventing a brake response delay of a vehicle.

Another aspect of the present disclosure provides an apparatus and a method for preventing a brake response delay of a vehicle via acceleration control.

Another aspect of the present disclosure provides an apparatus and a method for reducing an area in which it is difficult to respond to sudden braking due to a brake response delay phenomenon.

Another aspect of the present disclosure provides an apparatus and a method for reducing a possibility of a rear-end collision capable of occurring due to a zone with a high risk of accident occurrence or a sensor blind spot.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for preventing a brake response delay of a vehicle may include at least one processor, and a non-transitory memory storing computer-executable instructions executable by the at least one processor to carry out one or more operations. The one or more operations may include determining whether a host vehicle is located within a risk section with reference to position information, by a risk section determination device, and may also include outputting first required acceleration with reference to a current speed of the host vehicle and a setting speed range, based on determination that the host vehicle is located within the risk section, by an acceleration output device, and may further include outputting second required acceleration corresponding to a deceleration trigger signal, based on obtainment of the deceleration trigger signal, by the acceleration output device.

In an embodiment, the operations may include outputting a 1_1st required acceleration for performing deceleration of the host vehicle, via the acceleration output device, based on the current speed of the host vehicle being within the setting speed range.

In an embodiment, the operations may include performing any one of a process of outputting 2_1st required acceleration corresponding to first deceleration trigger signal corresponding to a first driving situation, based on obtainment of the first deceleration trigger signal, or a process of outputting 2_2nd required acceleration corresponding to a second deceleration trigger signal corresponding to a second driving situation, based on obtainment of the second deceleration trigger signal, by the acceleration output device.

In an embodiment, a 2_1st slope, which is an amount of change per unit time of the 2_1st required acceleration, may be smaller in magnitude than a 2_2nd slope, which is an amount of change per unit time of the 2_2nd required acceleration.

In an embodiment, the 1_1st required acceleration may be “0”.

In an embodiment, the operations may include outputting a 1_2nd required acceleration for performing acceleration of the host vehicle, via the acceleration output device, based on the current speed of the host vehicle being less than a lower limit setting speed in the setting speed range.

In an embodiment, the operations may include performing any one of a process of outputting 2_3rd required acceleration corresponding to third deceleration trigger signal corresponding to a third driving situation, based on obtainment of the third deceleration trigger signal, or a process of outputting 2_4th required acceleration corresponding to a fourth deceleration trigger signal corresponding to a fourth driving situation, based on obtainment of the fourth deceleration trigger signal, by the acceleration output device.

In an embodiment, the 1_2nd required acceleration may be less than threshold acceleration and a magnitude of a 1_2nd slope, which is an amount of change per unit time of the 1_2nd required acceleration, may be less than a threshold slope value.

In an embodiment, the threshold slope value may be set based on the current speed of the host vehicle.

In an embodiment, the operations may include outputting a third required acceleration for allowing the current speed of the host vehicle to meet the setting speed range, via an acceleration output device, based on determination that the host vehicle is located out of the risk section.

According to an aspect of the present disclosure, a method for preventing a brake response delay of a vehicle may include determining, by a risk section determination device, whether a host vehicle is located within a risk section with reference to position information, outputting, by an acceleration output device, first required acceleration with reference to a current speed of the host vehicle and a setting speed range, based on determination that the host vehicle is located within the risk section, and outputting, by the acceleration output device, second required acceleration corresponding to a deceleration trigger signal, based on obtainment of the deceleration trigger signal.

In an embodiment, the outputting of the first required acceleration may include outputting, by the acceleration output device, 1_1st required acceleration for performing deceleration of the host vehicle, based on the current speed of the host vehicle being within the setting speed range.

In an embodiment, the outputting of the second required acceleration may include performing any one of a process of outputting 2_1st required acceleration corresponding to first deceleration trigger signal corresponding to a first driving situation, based on obtainment of the first deceleration trigger signal, or a process of outputting 2_2nd required acceleration corresponding to a second deceleration trigger signal corresponding to a second driving situation, based on obtainment of the second deceleration trigger signal.

In an embodiment, a 2_1st slope, which is an amount of change per unit time of the 2_1st required acceleration, may be smaller in magnitude than a 2_2nd slope, which is an amount of change per unit time of the 2_2nd required acceleration.

In an embodiment, the 1_1st required acceleration may be “0”.

In an embodiment, the outputting of the first required acceleration may include outputting, by the acceleration output device, 1_2nd required acceleration for performing acceleration of the host vehicle, based on the current speed of the host vehicle being less than a lower limit setting speed in the setting speed range.

In an embodiment, the outputting of the second required acceleration may include performing, by the acceleration output device, any one of a process of outputting 2_3rd required acceleration corresponding to third deceleration trigger signal corresponding to a third driving situation, based on obtainment of the third deceleration trigger signal, or a process of outputting 2_4th required acceleration corresponding to a fourth deceleration trigger signal corresponding to a fourth driving situation, based on obtainment of the fourth deceleration trigger signal.

In an embodiment, the 1_2nd required acceleration may be less than threshold acceleration and a magnitude of a 1_2nd slope, which is an amount of change per unit time of the 1_2nd required acceleration, may be less than a threshold slope value.

In an embodiment, the threshold slope value may be set based on the current speed of the host vehicle.

In an embodiment, the method may further include outputting, by the acceleration output device, third required acceleration for allowing the current speed of the host vehicle to meet the setting speed range, based on determination that the host vehicle is located out of the risk section, after outputting the second required acceleration.

### BRIEF DESCRIPTION OF THE FIGURES

The above and other objects, features and advantages of the present disclosure will be more apparent from the following detailed description taken in conjunction with the accompanying drawings:

FIG. 1 is a block diagram illustrating an apparatus for preventing a brake response delay according to an embodiment of the present disclosure;

FIGS. 2A and 2B are drawings for comparing the result of causing a brake response delay phenomenon according to the related art with the result of improving a brake response delay phenomenon according to an embodiment of the present disclosure;

FIGS. 3A and 3B are drawings for comparing the result of causing a brake response delay phenomenon according to the related art with the result of improving a brake response delay phenomenon according to an embodiment of the present disclosure;

FIGS. 4A and 4B are drawings for comparing the result of causing a brake response delay phenomenon according to the related art with the result of improving a brake response delay phenomenon according to an embodiment of the present disclosure;

FIGS. 5A and 5B are drawings for comparing the result of causing a brake response delay phenomenon according to the related art with the result of improving a brake response delay phenomenon according to an embodiment of the present disclosure;

FIG. 6 is a flowchart for describing a method for preventing a brake response delay according to an embodiment of the present disclosure; and

FIG. 7 is a block diagram of a computing system for executing a method for preventing a brake response delay according to an embodiment of the present disclosure.

With regard to description of drawings, the same or similar denotations may be used for the same or similar components.

### DETAILED DESCRIPTION

Hereinafter, some embodiments of the present disclosure will be described in detail with reference to the accompanying drawings. In adding the reference numerals to the components of each drawing, it should be noted that the identical component is designated by the identical numerals even when they are displayed on other drawings. Further, in describing the embodiment of the present disclosure, a detailed description of well-known features or functions will be ruled out in order not to unnecessarily obscure the gist of the present disclosure. Particularly, various embodiments of the present disclosure may be described with reference to the accompanying drawings. However, it should be understood that this is not intended to limit the embodiments described in the disclosure to specific disclosed forms and includes various modifications, equivalents, and/or alternatives of embodiments of the disclosure. With regard to description of drawings, similar denotations may be used for similar components.

In describing the components of the embodiment according to the present disclosure, terms such as “first”, “second”, “A”, “B”, “(a)”, “(b)”, and the like may be used. These terms are merely intended to distinguish one component from another component, and the terms do not limit the nature, sequence or order of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application. For example, the terms, such as “first”, “second”, “1st”, “2nd”, or the like used in the present disclosure may be used to refer to various components regardless of the order and/or the priority and to distinguish one component from another component, but do not limit the components. For example, a first user device and a second user device indicate different user devices, irrespective of the order and/or priority. For example, without departing the scope of the present disclosure, a first component may be referred to as a second component, and similarly, a second component may be referred to as a first component.

In the present disclosure, the expressions “have”, “may have”, “include” and “comprise”, or “may include” and “may comprise” indicate existence of corresponding features (e.g., components such as numeric values, functions, operations, or parts), but do not exclude presence of additional features.

It will be understood that when a component (e.g., a component) is referred to as being “(operatively or communicatively) coupled with/to” or “connected to” another component (e.g., a second component), it can be directly coupled with/to or connected to the other component or an intervening component (e.g., a third component) may be present. In contrast, when a component (e.g., a first component) is referred to as being “directly coupled with/to” or “directly connected to” another component (e.g., a second component), it should be understood that there is no intervening component (e.g., a third component).

According to the situation, the expression “configured to” used in the present disclosure may be used interchangeably with, for example, the expression “suitable for”, “having the capacity to”, “designed to”, “adapted to”, “made to”, or “capable of”.

The term “configured to” is not limited to “specifically designed to” in hardware. Instead, the expression “a device configured to” may mean that the device is “capable of” operating together with another device or other parts. For example, a “processor configured to perform A, B, and C” may mean a generic-purpose processor (e.g., a central processing unit (CPU) or an application processor) which may perform corresponding operations by executing one or more software programs which store a dedicated processor (e.g., an embedded processor) for performing a corresponding operation or a memory device. Terms used in this specification are used to describe specified embodiments of the disclosure and are not intended to limit the scope of the disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the disclosure.

In the present disclosure, the expressions “A or B”, “at least one of A or/and B”, or “one or more of A or/and B”, and the like may include any and all combinations of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. Furthermore, in describing an embodiment of the present disclosure, each of such phrases as “A or B”, “at least one of A and B”, “at least one of A or B”, “A, B, or C”, “at least one of A, B, and C”, “at least one of A, B, or C”, and “at least one of A, B, or C, or any combination thereof” may include any one of, or all possible combinations of the items enumerated together in a corresponding one of the phrases. Particularly, the phrase such as “at least one of A, B, or C, or any combination thereof” may include “A”, “B”, or “C”, or “AB” or “ABC”, which is a combination thereof.

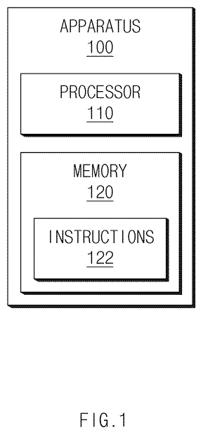

Hereinafter, various embodiments of the present disclosure will be described in detail with reference to FIGS. 1 to 7.

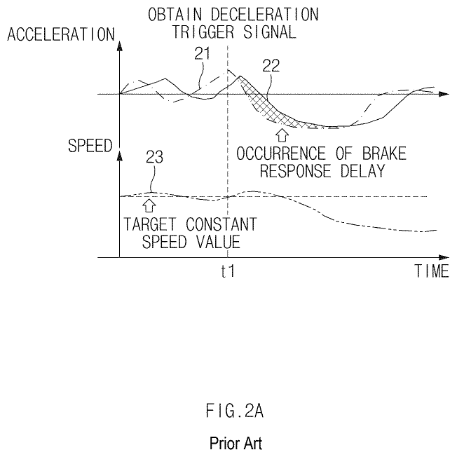

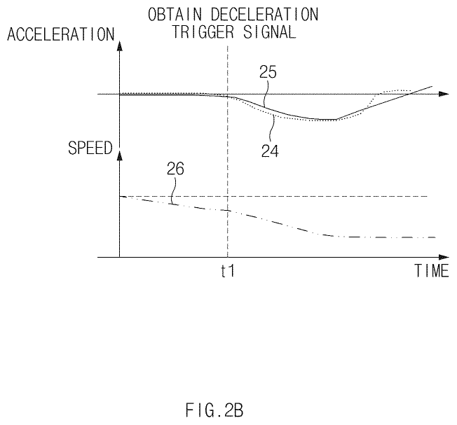

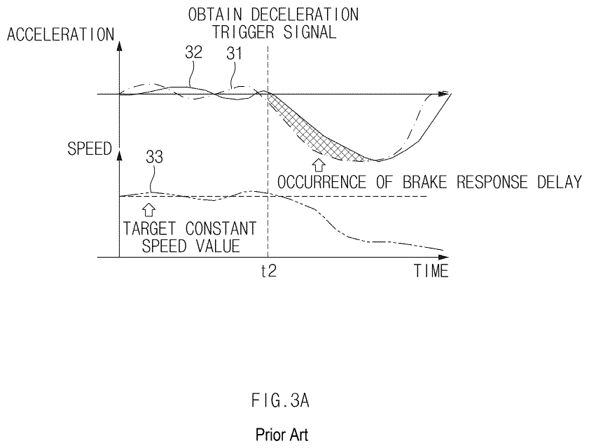

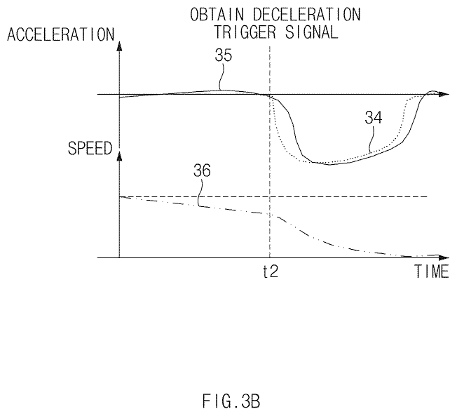

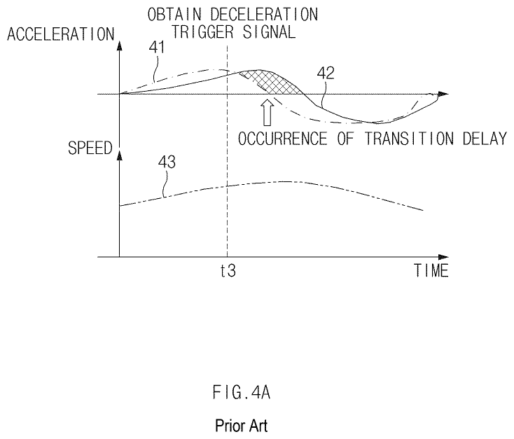

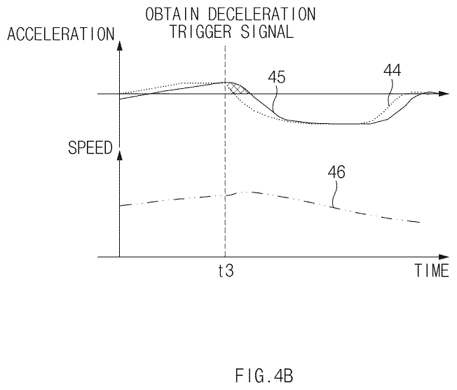

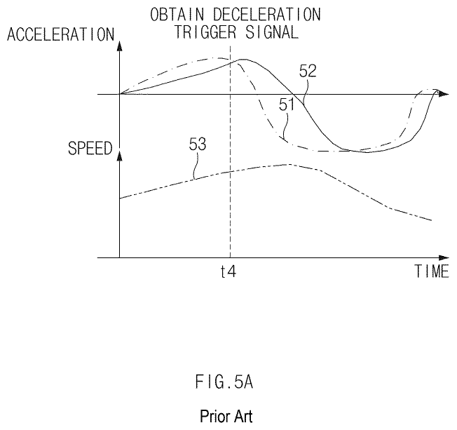

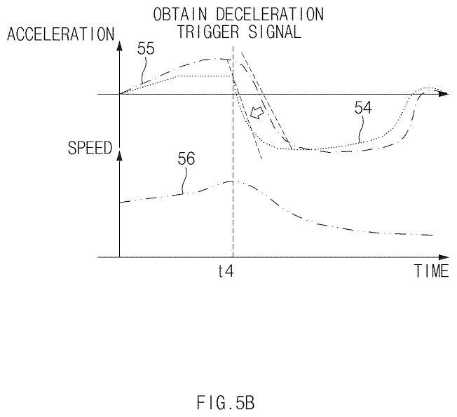

FIG. 1 is a block diagram illustrating an apparatus for preventing a brake response delay according to an embodiment of the present disclosure. FIGS. 2A and 2B are drawings for comparing the result of causing a brake response delay phenomenon according to the related art with the result of improving a brake response delay phenomenon according to an embodiment of the present disclosure. FIGS. 3A and 3B are drawings for comparing the result of causing a brake response delay phenomenon according to the related art with the result of improving a brake response delay phenomenon according to an embodiment of the present disclosure. FIGS. 4A and 4B are drawings for comparing the result of causing a brake response delay phenomenon according to the related art with the result of improving a brake response delay phenomenon according to an embodiment of the present disclosure. FIGS. 5A and 5B are drawings for comparing the result of causing a brake response delay phenomenon according to the related art with the result of improving a brake response delay phenomenon according to an embodiment of the present disclosure.

An apparatus 100 for preventing a brake response delay of a vehicle according to an embodiment may include a memory 120 storing instructions 122, such as computer-executable instructions, and at least one processor 110 for accessing the memory 120 and executing the instructions 122.

In some examples, the processor 110 may determine whether a host vehicle is located within a risk section, by means of a risk section determination device (not shown).

In some examples, the risk section determination device may determine whether the host vehicle is located within the risk section with reference to high definition map information.

In some examples, the host vehicle may be a vehicle which travels in a cruise control state. For example, the host vehicle may be a vehicle which travels such that the actual speed of the vehicle is close to a target speed through appropriate acceleration or deceleration control in response to a driving environment, in a state in which a target speed of the vehicle is set to 50 km/h.

Furthermore, the risk section may be a section set as having a high risk of accident occurrence, which may be a certain section including a specific zone (e.g., a school zone, a habitually illegal parking area, or the like) on a driving route.

For example, a section from a point 100 meters before entering the habitually illegal parking area to a point where the habitually illegal parking area is ended may be set to the risk section.

When it is determined that the host vehicle is located within the risk section, the processor 110 may output first required acceleration with reference to a current speed of the host vehicle and a setting speed range through an acceleration output device (not shown).

At this time, the first required acceleration may be output to minimize a response delay capable of being generated when the host vehicle transitions from driving control to braking control as a deceleration trigger, which will be described below, is obtained and sufficiently ensure the amount of braking for responding to a sudden braking situation.

Furthermore, the setting speed range may be set based on a target setting speed of the host vehicle.

For example, the setting speed range may be a range within a threshold from the target setting speed of the host vehicle.

In some examples, the threshold may be, but is not limited to, a fixed value. For example, as the target setting speed of the host vehicle is large, the threshold may have a large value.

When the deceleration trigger signal is obtained in a state in which the host vehicle travels in response to the first required acceleration, the processor 110 may output second required acceleration corresponding to the deceleration trigger signal.

In some examples, the deceleration trigger signal may be generated in various schemes.

For example, when a situation around the host vehicle is sensed using a sensor (e.g., a light detection and ranging (LiDAR) sensor, a radar sensor, an image sensor, or the like) loaded into the host vehicle and when it is determined that a situation in which the host vehicle should decelerate occurs (e.g., that the host vehicle passes through a point where the school zone starts) or that a situation in which the host vehicle should suddenly decelerate occurs (e.g., that an obstacle appears in front of the host vehicle at a short distance) based on the sensed result, the deceleration trigger signal may be generated.

Hereinafter, a description will be given in detail of the operation of the apparatus 100 for preventing the brake response delay according to an embodiment of the present disclosure.

For example, when it is determined that the host vehicle is located within the risk section, the processor 110 may determine whether a current speed of the host vehicle is within the setting speed range. As described above, the setting speed range may be set based on the target setting speed of the host vehicle. For example, the setting speed range may be a range within a threshold from the target setting speed of the host vehicle.

When the current speed (e.g., 45 km/h) of the host vehicle is within the setting speed range (e.g., 40 km/h to 60 km/h) (i.e., when the host vehicle is located within a constant speed maintenance control section), the processor 110 may output 1_1st required acceleration for performing deceleration of the host vehicle, by means of the acceleration output device.

In some examples, the 1_1st required acceleration may have a negative value such that direct deceleration of the host vehicle is performed, but not limited thereto. For example, the 1_1st required acceleration may have a value of 0 m/s² such that natural deceleration is performed due to driving resistance of the host vehicle.

When a first deceleration trigger signal corresponding to a first driving situation is obtained, in a state in which the host vehicle travels in response to the 1_1st required acceleration, the processor 110 may output 2_1st required acceleration corresponding to the first deceleration trigger signal by means of the acceleration output device.

For example, the first driving situation may have a smaller possibility of accident occurrence and a smaller amount of braking required than a second driving situation which will be described with reference to FIGS. 3A and 3B. For example, the first driving situation may be a driving situation in which the host vehicle passes through a point where the school zone or the habitually illegal parking area starts. When the first deceleration trigger signal corresponding to the first driving situation is obtained, the processor 110 may output the 2_1st required acceleration.

For instance, when the host vehicle is located within the risk section, the processor 110 may output the 1_1st required acceleration to guide the host vehicle to decelerate in advance, such that the host vehicle quickly decelerates without a brake response delay depending on a deceleration command (e.g., the 2_1st required acceleration) in a driving situation (i.e., the first driving situation) which actually requires deceleration.

Referring to FIG. 2A for the related art, when a host vehicle travels in its cruise control state, a processor may output a required acceleration command value 21 for repeating acceleration and deceleration to maintain a current speed 23 of the host vehicle as a target speed (or a target constant speed value) within a setting speed range. When the host vehicle is accelerating at a time point t1 when a first deceleration trigger signal is obtained, a brake response delay occurs until the host vehicle follows the required acceleration command value 21 corresponding to the first deceleration trigger signal and actually switches to its braking state. This may be identified through a difference between the required acceleration command value 21 and a required acceleration vehicle following value 22 of FIG. 2A.

On the other hand, referring to FIG. 2B illustrating the result of improving a brake response delay phenomenon according to an embodiment of the present disclosure, when a current speed 26 of a host vehicle is within a setting speed range in a state in which the host vehicle enters a risk section while traveling in a cruise control state, the processor 110 may output 1_1st required acceleration, which is a required acceleration command value 24, to guide the host vehicle to decelerate and may output the required acceleration command value 24, which is 2_1st required acceleration corresponding to a first deceleration trigger signal obtained at a time point t1 when a first driving situation actually requiring deceleration occurs, such that the host vehicle quickly follows the 2_1st required acceleration to minimize a brake response delay. This may be identified through the required acceleration command value 24 and a required acceleration vehicle following value 25 of FIG. 2B.

As another example, when a second deceleration trigger signal corresponding to a second driving situation is obtained, in a state in which the host vehicle travels in response to the 1_1st required acceleration, the processor 110 may output 2_2nd required acceleration corresponding to the second deceleration trigger signal through the acceleration output device.

For example, the second driving situation may have a larger possibility of accident occurrence and a larger amount of braking required than the first driving situation described above with reference to FIGS. 2A and 2B. For example, the second driving situation may be a driving situation predicted that a rear-end collision will occur without sudden braking, for example, a situation in which a person appears at a close distance on a driving route of the host vehicle. When the second deceleration trigger signal corresponding to the second driving situation is obtained, the processor 110 may output the 2_2nd required acceleration.

For example, a 2_2nd slope, which is an amount of change per unit time of the 2_2nd required acceleration, may be larger in magnitude than a 2_1st slope, which is an amount of change per unit time of the 2_1st required acceleration described above.

In other words, when the host vehicle is located within the risk section, the processor 110 may output the 1_1st required acceleration to guide the host vehicle to decelerate in advance, such that the host vehicle quickly and suddenly decelerates without a brake response delay depending on a sudden deceleration command (e.g., the 2_2nd required acceleration) generated in a driving situation (i.e., the second driving situation) which actually requires sudden deceleration.

Referring to FIG. 3A for the related art, when a host vehicle drives in its cruise control state, the processor outputs a required acceleration command value 31 for repeating acceleration and deceleration to maintain a current speed 33 of the host vehicle as a target speed (or a target constant speed value) within a setting speed range. When the host vehicle is accelerating at a time point t2 when a second deceleration trigger signal is obtained, a brake response delay occurs until the host vehicle follows the required acceleration command value 31 and actually switches to its sudden braking state although the processor outputs the required acceleration command value 31 for commanding the host vehicle to perform sudden deceleration in response to the second deceleration trigger signal. This may be identified through a difference between the required acceleration command value 31 and a required acceleration vehicle following value 32 of FIG. 3A.

On the other hand, referring to FIG. 3B illustrating the result of improving a brake response delay phenomenon according to an embodiment of the present disclosure, when a current speed 36 of a host vehicle is within a setting speed range in a state in which the host vehicle enters a risk section while traveling in its cruise control state, the processor 110 may output 1_1st required acceleration, which is a required acceleration command value 34, to guide the host vehicle to decelerate in advance and may output a required acceleration command value 34, which is 2_2nd required acceleration corresponding to a second deceleration trigger signal obtained at a time point t2 when a second driving situation which actually requires sudden deceleration, such that the host vehicle quickly follows the 2_2nd required acceleration to minimize a brake response delay. This may be identified through the required acceleration command value 34 and a required acceleration vehicle following value 35 of FIG. 3B.

Meanwhile, when the current speed (e.g., 20 km/h) of the host vehicle is less than a lower limit setting speed (i.e., 35 km/h) in the setting speed range (e.g., 35 km/h to 55 km/h), the processor 110 may output 1_2nd required acceleration for performing acceleration of the host vehicle, through the acceleration output device.

For example, as described above with reference to FIGS. 2B and 3B, after the host vehicle enters the risk section in the cruise control state, the current speed of the host vehicle may continuously decrease to be less than the lower limit setting speed as the host vehicle follows the 1_1st required acceleration (e.g., 0 m/s²). Alternatively, although the current speed of the host vehicle is less than the lower limit setting speed as vehicle congestion is detected in front of the host vehicle, the vehicle congestion may be resolved. In such examples, the processor 110 may output the 1_2nd required acceleration to return the speed of the host vehicle within the setting speed range.

In some examples, the 1_2nd required acceleration may be less than threshold acceleration.

In such examples, as an upper limit value of the 1_2nd required acceleration is set, a delay may be prevented from being generated when the host vehicle transitions from its driving state to its braking state.

Furthermore, the magnitude of the 1_2nd slope, which is an amount of change per unit time of the 1_2nd required acceleration, may be less than a threshold slope value. At this time, the threshold slope value may be set based on the current speed of the host vehicle. For example, the larger the current speed of the host vehicle, the smaller the threshold slope value may be set to be.

For instance, as the slope of the 1_2nd required acceleration is set to be small, a delay may be prevented from being generated when the host vehicle transitions from its driving state to its braking state.

When a third deceleration trigger signal corresponding to a third driving situation is obtained, in a state in which the host vehicle accelerates in response to the 1_2nd required acceleration, the processor 110 may output 2_3rd required acceleration corresponding to the third deceleration trigger signal through the acceleration output device.

For example, the third driving situation and the third deceleration trigger signal may be the same as or similar to the first driving situation and the first deceleration trigger signal, which are described above, respectively. A fourth driving situation and a fourth deceleration trigger signal, which will be described below, may be the same as or similar to the second driving situation and the second deceleration trigger signal, which are described above, respectively. Thus, a duplicated description thereof may be omitted.

In such examples, when the current speed of the host vehicle is very low although the host vehicle is located within the risk section, the processor 110 may output the 1_2nd required acceleration such that the host vehicle accelerates, which may limit an upper limit value and a slope of the 1_2nd required acceleration such that the host vehicle quickly decelerates without a brake response delay depending on a deceleration command (e.g., the 2_3rd required acceleration) generated in a driving situation (i.e., the third driving situation) which actually requires deceleration.

Referring to FIG. 4A for the related art, when the host vehicle travels in its cruise control state, the processor outputs a required acceleration command value 41 for guiding the host vehicle to accelerate to return a current speed 43 of the host vehicle to a target speed (or a target constant speed value) within a setting speed range. However, when the host vehicle follows a too large required acceleration command value to accelerate immediately before a time point t3 when a third deceleration trigger signal is obtained, a delay occurs until the host vehicle follows the required acceleration command value 41 corresponding to the third deceleration trigger signal and actually switches to its braking state. This may be identified through a difference between the required acceleration command value 41 and a required acceleration vehicle following value 42 of FIG. 4A.

On the other hand, referring to FIG. 4B illustrating the result of improving a brake response delay phenomenon according to an embodiment of the present disclosure, when the host vehicle accelerates to return within a setting speed range in a state in which the host vehicle enters a risk section in its cruise control mode, the processor 110 may output a 1_2nd required acceleration, which is a required acceleration command value 44, to guide the host vehicle not to accelerate very suddenly and may output a required acceleration command value 44, which is 2_3rd required acceleration corresponding to a third deceleration trigger signal obtained at a time point t3 when a third driving situation actually requiring deceleration occurs, such that the host vehicle quickly follows the 2_3rd required acceleration to minimize a brake response delay. This may be identified through the required acceleration command value 44 and a required acceleration vehicle following value 45 of FIG. 4B.

As another example, when a fourth deceleration trigger signal corresponding to a fourth driving situation (or a driving situation requiring sudden braking) is obtained, in a state in which the host vehicle accelerates in response to the 1_2nd required acceleration, the processor 110 may output 2_4th required acceleration corresponding to the fourth deceleration trigger signal through the acceleration output device.

In some examples, when the host vehicle is located within the risk section, the processor 110 may output the 1_2nd required acceleration to guide the host vehicle to decelerate in advance, such that the host vehicle quickly and suddenly decelerates without a brake response delay depending on a sudden deceleration command (e.g., the 2_2nd required acceleration) generated in a driving situation (i.e., the second driving situation) which actually requires sudden deceleration.

In some examples, when the current speed 46 of the host vehicle is very low although the host vehicle is located within the risk section, the processor 110 may output the 1_2nd required acceleration such that the host vehicle accelerates, which may limit an upper limit value and a slope of the 1_2nd required acceleration such that the host vehicle quickly and suddenly decelerates without a brake response delay depending on a deceleration command (e.g., the 2_4th required acceleration) generated in a driving situation (i.e., the fourth driving situation) which actually requires deceleration.

Referring to FIG. 5A for the related art, when the host vehicle travels in its cruise control state, the processor outputs a required acceleration command value 51 for guiding the host vehicle to accelerate to return a current speed 53 of the host vehicle to a target speed (or a target constant speed value) within a setting speed range. However, when the host vehicle follows a too large required acceleration command value to accelerate immediately before a time point t3 when a fourth deceleration trigger signal is obtained, a brake response delay occurs until the host vehicle follows the required acceleration command value 51 and actually switches to its sudden braking state although the processor outputs the required acceleration command value 51 for commanding the host vehicle to perform sudden deceleration in response to the fourth deceleration trigger signal. This may be identified through a difference between the required acceleration command value 51 and a required acceleration vehicle following value 52 of FIG. 5A.

On the other hand, referring to FIG. 5B illustrating the result of improving a brake response delay phenomenon according to an embodiment of the present disclosure, when the host vehicle accelerates to return within a setting speed range in a state in which the host vehicle enters a risk section in its cruise control mode, the processor 110 may output a 1_2nd required acceleration, which is a required acceleration command value 54, to guide the host vehicle not to accelerate very suddenly and may output a required acceleration command value 54, which is 2_4th required acceleration corresponding to a fourth deceleration trigger signal obtained at a time point t4 when a fourth driving situation actually requiring deceleration occurs, such that the host vehicle quickly follows the 2_4th required acceleration to minimize a brake response delay. This may be identified through the required acceleration command value 54 and a required acceleration vehicle following value 55 of FIG. 5B.

When it is determined that the host vehicle passes through the risk section depending on the method, the processor 110 may increase the speed of the host vehicle again.

For example, when it is determined that the host vehicle is located within the risk section, the processor 110 may output third required acceleration for allowing the current speed 56 of the host vehicle to meet the setting speed range, through the acceleration output device.

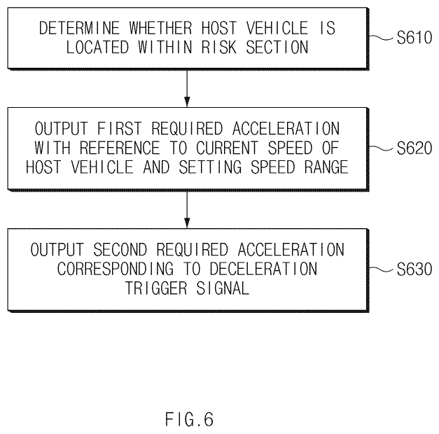

FIG. 6 is a flowchart for describing a method for preventing a brake response delay according to an embodiment of the present disclosure. However, in other embodiments, blocks S610-S630 may be performed in a different order.

At block S610, a risk section determination device may determine whether a host vehicle is located within a risk section with reference to position information.

When it is determined that the host vehicle is located within the risk section in block S610, at block S620, an acceleration output device may output first required acceleration with reference to a current speed of the host vehicle and a setting speed range.

When a deceleration trigger signal is obtained in a state in which the host vehicle follows the first required acceleration output in block S620 to travel, at block S630, the acceleration output device may output second required acceleration corresponding to a deceleration trigger signal.

The related art copes with a brake response delay in a manner which decreases a target speed in a speed domain, whereas various embodiments of the present disclosure copes with a brake response delay by limiting the amount of acceleration in an acceleration domain (e.g., outputting a required acceleration command value as “0” before the deceleration trigger signal is obtained) or outputting a negative acceleration command value in advance (e.g., decreasing the slope of the required acceleration before the deceleration trigger signal is obtained or setting the upper limit value of the required acceleration). Thus, a transition section delay problem in a section where the host vehicle transitions from the driving state to the braking state may be improved, and a problem in which the amount of braking is insufficient in the sudden braking situation may be improved.

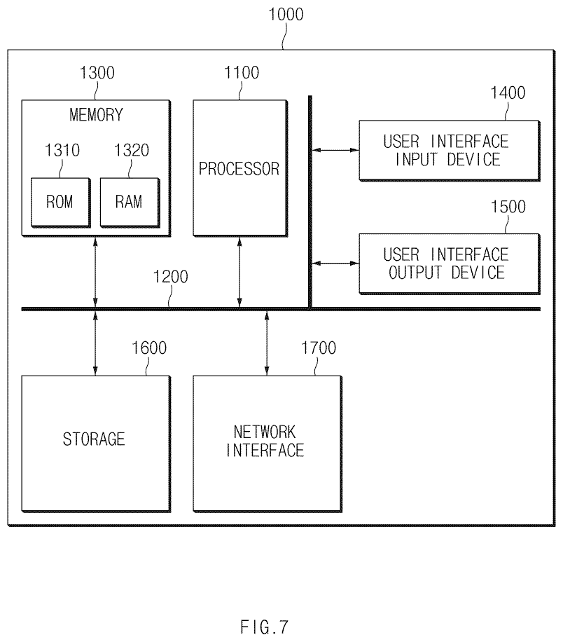

FIG. 7 is a diagram illustrating a computing system associated with a method for preventing a brake response delay of a vehicle or an apparatus using the same according to various embodiments of the present disclosure.

Referring to FIG. 7, a computing system 1000 about the method for preventing the brake response delay of the vehicle or the apparatus using the same may include at least one processor 1100, a memory 1300, a user interface input device 1400, a user interface output device 1500, a storage 1600, and a network interface 1700, which may be connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

The above-described embodiments may be implemented with hardware components, software components, and/or a combination of hardware components and software components. For example, the devices, methods, and components described in the embodiments may be implemented in general-use computers or special-purpose computers, such as a processor, a controller, an arithmetic logic unit (ALU), a digital signal processor, a microcomputer, a field programmable array (FPGA), a programmable logic unit (PLU), a microprocessor, or any device which may execute instructions and respond. A processing unit may perform an operating system (OS) or a software application running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively instruct the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one computer-readable storage media.

The methods according to the embodiments may be implemented with program instructions which may be executed through various computer means and may be recorded in computer-readable media. The computer-readable media may include program instructions, data files, data structures, and the like alone or in combination, and the program instructions recorded on the media may be specially designed and configured for an embodiment or may be known and usable to those skilled in the art of computer software. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter.

The above-described hardware devices may be configured to act as one or a plurality of software modules to perform the operations of the embodiments, or vice versa.

Even though the embodiments are described with reference to restricted drawings, it may be obviously to one skilled in the art that the embodiments are variously changed or modified based on the above description. For example, adequate effects may be achieved even if the foregoing processes and methods are carried out in different order than described above, and/or the aforementioned components, such as systems, structures, devices, or circuits, are combined or coupled in different forms and modes than as described above or be substituted or switched with other components or equivalents.

According to the present disclosure, the apparatus and the method for preventing the brake response delay of the vehicle may be provided.

According to the present disclosure, the apparatus and the method for preventing the brake response delay of the vehicle through acceleration control may be provided.

According to the present disclosure, the apparatus and the method for reducing the area in which it is impossible to respond to the sudden braking due to the brake response delay phenomenon may be provided.

According to the present disclosure, the apparatus and the method for reducing the possibility of the rear-end collision capable of occurring due to the zone with the high risk of accident occurrence or the sensor blind spot may be provided.

In addition, various effects ascertained directly or indirectly through the present disclosure may be provided.

Therefore, other implements, other embodiments, and equivalents to claims are within the scope of the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed based on the accompanying claims, and all the technical ideas within the scope equivalent to the claims should be included in the scope of the present disclosure.

1. An apparatus for preventing a brake response delay of a vehicle, the apparatus comprising:
at least one processor; and
a non-transitory memory storing computer-executable instructions executable by the at least one processor to carry out the operations comprising:
determining whether a host vehicle is located within a risk section with reference to position information, by a risk section determination device; and
outputting first required acceleration with reference to a current speed of the host vehicle and a setting speed range, based on determination that the host vehicle is located within the risk section, by an acceleration output device, and outputting second required acceleration corresponding to a deceleration trigger signal, based on obtainment of the deceleration trigger signal, by the acceleration output device.

2. The apparatus of claim 1, wherein the operations further comprise:
outputting a 1_1st required acceleration for performing deceleration of the host vehicle, via the acceleration output device, based on the current speed of the host vehicle being within the setting speed range.

3. The apparatus of claim 2, wherein the operations further comprise:
performing any one of a process of outputting 2_1st required acceleration corresponding to first deceleration trigger signal corresponding to a first driving situation, based on obtainment of the first deceleration trigger signal, or a process of outputting 2_2nd required acceleration corresponding to a second deceleration trigger signal corresponding to a second driving situation, based on obtainment of the second deceleration trigger signal, by the acceleration output device.

4. The apparatus of claim 3, wherein a 2_1st slope, which is an amount of change per unit time of the 2_1st required acceleration, is smaller in magnitude than a 2_2nd slope, which is an amount of change per unit time of the 2_2nd required acceleration.

5. The apparatus of claim 2, wherein the 1_1st required acceleration is “0”.

6. The apparatus of claim 1, wherein the operations further comprise:
outputting 1_2nd required acceleration for performing acceleration of the host vehicle, via the acceleration output device, based on the current speed of the host vehicle being less than a lower limit setting speed in the setting speed range.

7. The apparatus of claim 6, wherein the operations further comprise:
performing any one of a process of outputting 2_3rd required acceleration corresponding to third deceleration trigger signal corresponding to a third driving situation, based on obtainment of the third deceleration trigger signal, or a process of outputting 2_4th required acceleration corresponding to a fourth deceleration trigger signal corresponding to a fourth driving situation, based on obtaining of the fourth deceleration trigger signal, by the acceleration output device.

8. The apparatus of claim 6, wherein the 1_2nd required acceleration is less than a threshold acceleration and a magnitude of a 1_2nd slope, which is an amount of change per unit time of the 1_2nd required acceleration, is less than a threshold slope value.

9. The apparatus of claim 8, wherein the threshold slope value is set based on the current speed of the host vehicle.

10. The apparatus of claim 1, wherein the operations further comprise:
outputting a third required acceleration for allowing the current speed of the host vehicle to meet the setting speed range, via an acceleration output device, based on determination that the host vehicle is located out of the risk section.

11. A method, comprising:
determining, by a risk section determination device, whether a host vehicle is located within a risk section with reference to position information;
outputting, by an acceleration output device, first required acceleration with reference to a current speed of the host vehicle and a setting speed range, based on determination that the host vehicle is located within the risk section; and
outputting, by the acceleration output device, second required acceleration corresponding to a deceleration trigger signal, based on obtainment of the deceleration trigger signal.

12. The method of claim 11, wherein the outputting of the first required acceleration comprises:
outputting, by the acceleration output device, 1_1st required acceleration for performing deceleration of the host vehicle, based on the current speed of the host vehicle being within the setting speed range.

13. The method of claim 12, wherein the outputting of the second required acceleration comprises:
performing any one of a process of outputting 2_1st required acceleration corresponding to first deceleration trigger signal corresponding to a first driving situation, based on obtainment of the first deceleration trigger signal, or a process of outputting 2_2nd required acceleration corresponding to a second deceleration trigger signal corresponding to a second driving situation, based on obtainment of the second deceleration trigger signal.

14. The method of claim 13, wherein a 2_1st slope, which is an amount of change per unit time of the 2_1st required acceleration, is smaller in magnitude than a 2_2nd slope, which is an amount of change per unit time of the 2_2nd required acceleration.

15. The method of claim 12, wherein the 1_1st required acceleration is “0”.

16. The method of claim 11, wherein the outputting of the first required acceleration comprises:
outputting, by the acceleration output device, 1_2nd required acceleration for performing acceleration of the host vehicle, based on the current speed of the host vehicle being less than a lower limit setting speed in the setting speed range.

17. The method of claim 16, wherein the outputting of the second required acceleration comprises:
performing, by the acceleration output device, any one of a process of outputting 2_3rd required acceleration corresponding to third deceleration trigger signal corresponding to a third driving situation, based on obtainment of the third deceleration trigger signal, or a process of outputting 2_4th required acceleration corresponding to a fourth deceleration trigger signal corresponding to a fourth driving situation, based on obtainment of the fourth deceleration trigger signal.

18. The method of claim 16, wherein the 1_2nd required acceleration is less than a threshold acceleration and a magnitude of a 1_2nd slope, which is an amount of change per unit time of the 1_2nd required acceleration, is less than a threshold slope value.

19. The method of claim 18, wherein the threshold slope value is set based on the current speed of the host vehicle.

20. The method of claim 11, further comprising:
outputting, by the acceleration output device, a third required acceleration for allowing the current speed of the host vehicle to meet the setting speed range, based on the determination that the host vehicle is located out of the risk section, after outputting the second required acceleration.
